(19) United States
(12) Patent Application Publication
(10) Pub. No.: US 2009/0277415 A1
(43) Pub. Date: Nov. 12, 2009

(54) CYLINDER CRANKCASE FOR A MOTOR VEHICLE

(76) Inventors: Herbert Moeding, Bad Friedrichshall (DE); Stephan Beer, Heilbronn (DE); Manfred Laudenklos, Schoeneck (DE)

Correspondence Address: Muncy, Geissler, Olds & Lowe, PLLC, P.O. BOX 1364, FAIRFAX, VA, 22038-1364, US

(21) Appl. No.: 12/463,929

(22) Filed: May 11, 2009

Related U.S. Application Data
(63) Continuation of application No. PCT/EP2007/009242, filed on Oct. 25, 2007.

(30) Foreign Application Priority Data
Nov. 10, 2006 (DE) 10 2006 053 018.7

(51) Int. Cl. F02F 7/00; B22F 3/105; B22F 3/11

(52) U.S. Cl. 123/195 R; 419/23; 419/10; 419/2; 75/230

(57) ABSTRACT

A quasi-monolithic cylinder crankcase is provided that is cast in a metal permanent mold for an internal combustion engine having an infiltration body penetrating the cylinder crankcase, wherein the infiltration body is composed of an inductively welded, open-cell metal foam.

This nonprovisional application is a continuation of International Application No. PCT/EP2007/009242, which was filed on Oct. 25, 2007, and which claims priority to German Patent Application No. DE 10 2006 053 018.7, which was filed in Germany on Nov. 10, 2006, and which are both herein incorporated by reference.

### BACKGROUND OF THE INVENTION

1. Field of the Invention

The invention relates to a quasi-monolithic cylinder crankcase, cast in a metal permanent mold, for an internal combustion engine having an infiltration body penetrating the cylinder crankcase. The invention further relates to an infiltration body and a method for producing such an infiltration body for use in and for the manufacture of a cylinder crankcase for an internal combustion engine.

2. Description of the Background Art

Internal combustion engines used in today's motor vehicles are for the most part made of light metal alloys. Usually, the cylinder crankcases of these internal combustion engines are made of aluminum or alloys thereof, but magnesium alloys, which, like aluminum, have the advantage of a low specific density and thus a low weight, are also used. In order to satisfy the stringent and ever more demanding requirements concerning aspects such as pressure during compression, hypereutectic aluminum-silicon alloys—whose strength and elastic modulus approach those of ferrous materials, depending on the alloy—are employed in the area of the aluminum alloys. One disadvantage of these high-strength aluminum alloys is that while they achieve high strengths, which are favorable with regard to the demands placed on the cylinder crankcase, they are also costly to machine as a result of their high strength.

In order to utilize the advantage of the high-strength aluminum alloys and also be able to machine the cylinder crankcase easily, EP 0 449 356 B1 describes a cylinder crankcase that is alloyed only locally, so that the required tribological properties are provided in the highly stressed area of the cylinder face, yet the cylinder crankcase is also easy to machine. The document describes a sleeveless single cylinder or multiple cylinder block cast in a metallic permanent mold using aluminum alloy with silicon grains embedded in the aluminum matrix, wherein a molded fibrous article in the shape of a hollow cylinder made of ceramic fibers with inserted silicon particles which forms the cylinder face and is penetrated by a hypoeutectic aluminum alloy, is cast in the region of the cylinder face. In this process, the separately produced molded fibrous article is placed on a spindle of the casting mold, and the aluminum alloy melt is introduced into the mold and solidified under pressure. The aluminum alloy melt is preferably solidified under a pressure of at least 30 bar, but in particular 200 to 1,000 bar. The method described here is also known as the squeeze casting method. During the application of pressure following the introduction of the aluminum alloy melt into the casting mold, the aluminum alloy melt is infiltrated into the molded fibrous article, so that a composite material or a locally alloyed, quasi-monolithic cylinder block, can be produced as a function of the preheating of the molded fibrous article and the alloy composition.

The use of porous, infiltratable molded articles for producing engine blocks is also described in DE 196 17 457 A1. For the production by casting of the inventive blocks, the prefabricated cores are placed in the casting molds that provide the outer dimensions, and the molten metal is poured into the resulting hollow spaces. In this process, the outer regions of the porous cores begin to melt due to the temperature of the melt, resulting in an intimate mechanical connection capable of bearing loads. The degree of melting here can be influenced by making the temperature of the melt higher or lower or by setting the melting points of the materials used to different levels. No reference to casting under pressure can be found in the document. Various processes are known for producing the porous molded articles used herein. Thus, thermal sintering from metal particles is described, wherein the particles are poured into a mold and heated into the range of the melting point, causing them to melt together firmly at their points of contact. This creates a mechanically stable composite with a large number of small hollow spaces that are connected together. Also described is production of the sintered metal molded pieces, wherein the metal particles are poured into a separable ceramic permanent mold, the permanent mold is placed inside an electrical coil, and the particles are heated inductively at a high frequency. Moreover, the use of what are known as open-cell metal foams for producing the flow passages in motors is described.

The production of porous, flat material bonds is also disclosed in DE 197 22 088 A1, which corresponds to U.S. Pat. No. 6,533,995. Here, a powder coating or a powder-based molded article is briefly subjected to an alternating magnetic field in the frequency range from approximately 10 kHz to 120 MHz, in order to produce in the powder coating or powder-based molded article an inductive current of such an energy density that the points of contact among the powder particles fuse together at their points of contact. The sole condition is that the powder must be electrically conductive so that an electric current can be induced. This method takes place at melting temperature, so that the powder particles melt together at their points of contact. The nature of the fusing process produces a strong, porous material bond that has good dimensional stability.

### SUMMARY OF THE INVENTION

It is therefore an object of the invention to provide a cylinder crankcase and a method for producing a cylinder crankcase that is quasi-monolithic in design and has strength values that differ locally. Furthermore, a further object of the invention is to provide a method for producing a cylinder crankcase that is independent of the casting method.

The solution to the inventive object with respect to producing a cylinder crankcase is provided in that the infiltration body in a cylinder crankcase is composed of an inductively welded, open-cell molded article. Using the inventive solution, a cylinder crankcase is provided that is quasi-monolithic in design but has strength values that differ locally in the highly stressed regions. Here, the choice of materials for producing the infiltration body, the size of the metal particles and hence the size of the cavities between the metal particles in the molded article, and the preheating temperature of the infiltration body prior to its casting into the cylinder crankcase, make it possible to establish defined and specifically predeterminable hardnesses in locally highly stressed areas of the cylinder crankcase and thus to achieve the required tribological properties and also to establish the necessary sliding properties in the bearing block area.

The use of an inductively welded infiltration body is also advantageous because the inductively welded molded article has a relatively high intrinsic strength, so that the inventive cylinder crankcase can be produced as a pressure or squeeze cast cylinder crankcase. This advantage has beneficial effects on the structural design of the cylinder crankcase and also on the costs of manufacturing the cylinder crankcase. In particular, the infiltration bodies are easy to handle, since they are dimensionally stable and, as infiltration bodies, possess high strength themselves. The invention thus provides cylinder crankcases whose static and dynamic strength properties and/or wear resistance can be established in a local and controlled manner.

The metal particles for creating the infiltration body, which can also be called a molded article or green compact, includes metal particles based on iron or nonferrous metals. The infiltration body is preferably, but not exclusively, made of the metals iron and/or nickel and/or chromium and/or manganese and/or their alloys. The condition here is that the metal powder used, which constitutes the metal particles to form the green compact, must be electrically conductive, since the green compact is produced by an induced current having an energy density such that the points of contact between the metal particles can be bonded together.

The metal particles here can have an average size from 0.1 mm to 1.5 mm, so that a degree of porosity of the infiltration body can be established, depending on the size or diameter of the metal particles used. In this context, the infiltration body as a reinforcing element is made from metal particles by induction welding of the metal particles, wherein the metal particles are introduced into the mold by pressure packing or under vibration.

The degree of porosity of the infiltration body is between 20% and 70%. The degree of porosity to be established depends on the infiltration conditions, which is to say the geometry of the infiltration body and the pressure build-up specifications of the casting process. It is possible according to the invention to use organic or inorganic fillers in the production of the infiltration body for porosities above 50%. Resins and/or plastics and/or cellulose and/or gelatins and/or salts can serve as fillers here. It has been shown that no preheating of the infiltration body is required at high degrees of porosity. In contrast, if very high elastic moduli are to be achieved in the locally reinforced areas of the cylinder crankcase, this requirement results in a relatively low pore volume of 20% to 50%, so that the infiltration bodies must be preheated to a temperature of 300° C. to 800° C. before placement in the mold. The preheating of the infiltration body facilitates the infiltration of the light metal alloy melt, and makes it possible to influence the formation of the intermetallic compounds between the casting material and the metal particles that make up the infiltration body. It is thus easy to understand that an infiltration body preheated to, e.g., 500° C. forms more intermetallic compounds than an infiltration body with a lower pore volume that is preheated less, since the energy stored in the infiltration body is available for the formation of alloys. Due to the high heat capacity of the infiltration body, which is made of an open-cell metal foam, the heat loss during placement in the mold is small, so that the infiltration conditions are significantly improved as compared to the ceramic foams known from the prior art.

In the infiltration of magnesium alloys, for example, open-cell metal foams based on iron are inert as infiltration bodies, so no reactions occur and no reproducible bond strengths result. In contrast, if metal foams based on iron or nonferrous metals are infiltrated with aluminum alloys, a nearly complete conversion of the metal foam into aluminides can be achieved by means of the particle size and preheating temperature, resulting in a composite material with high wear resistance. These highly wear-resistant composite materials then serve as cylinder faces or as bearings in the crankshaft region, for example.

The material properties of the cylinder crankcase produced according to the invention are defined and can be established in a reproducible manner through the particle size, the choice of materials for the infiltration body, the choice of porosity in the infiltration body, and an optional preheating of the infiltration body. Another option for producing the intermetallic phases and thus for influencing the material properties, for example the strength, is to coat the surface of the infiltration body so as to reduce or block to the greatest extent possible the conversion of the metal particles by the casting material. In this regard, the surface of the infiltration body can be oxidized or nitrided or provided with an inorganic coating. In addition to the aforementioned quantities influencing the formation of the intermetallic phases, it is thus possible to form multiple types of intermetallic compounds as well as a core region of pure metal in the vicinity of the local strength enhancement of the cylinder crankcase. If the infiltration body is made of iron particles, for instance, then a core region of pure iron is formed from a first layer of FeAl as a function of particle size, porosity, preheating and coating, if the casting material is an aluminum alloy, for example. Over this first iron aluminide layer is formed another intermetallic compound of iron aluminide in the form of Fe₂Al₅, and an intermetallic compound in the form of FeAl₃ would form as a third surrounding layer. Naturally, this example is not limiting and represents only one example embodiment of the formation of iron aluminides when the metal particles have iron and the casting material for producing the cylinder crankcase have an aluminum-based alloy. It is also possible as an example, however, that with such a material combination the core region includes pure iron aluminides, the first surrounding region includes iron aluminides in the form of Fe₂Al₅, and the second surrounding region has iron aluminides in the form of FeAl₃. The establishment of the intermetallic compounds can be affected in a defined manner by means of the aforementioned adjustable parameters with respect to the desired static or dynamic strength enhancement.

Induction welding of the metal particles to produce the infiltration body represents an economical manufacturing method. Depending on the desired porosity, fillers are mixed with the metal particles and are then dissolved or vaporized when the liquid melt is poured into the mold. Examples of fillers are organic resins and/or plastics, and/or cellulose and/or gelatins, but also organic components, such as, e.g., salts. An advantage of induction welding is the great dimensional stability. According to the invention, the infiltration body is made, for example, of metal particles fabricated under pressure so that a green compact is formed that subsequently is subjected to an inductive medium frequency field with a sufficiently large energy density that welding takes place at the points of contact of the metal particles. The induced medium frequency field here has a frequency from 1 kHz to 400 kHz and can be changed in accordance with the material used for the metal particles and the selected particle size, with the welding at the contact points of the metal particles being essential. In induction welding, a protective gas or forming gas atmosphere is possible, but not essential to the invention, since any oxide coatings present on the metal particles are penetrated due to the high induced voltage and the resultant skin effect at the points of contact over the entire cross-section of the infiltration body. Organically based fillers or fixing components are vaporized during the induction welding process. The welding process automatically regulates itself in correspondence with the particle size according to the law of electromagnetic induction.

An important advantage of inductively welded infiltration bodies is that the infiltration bodies can be used for pressurized casting processes, since the infiltration bodies withstand the pressures during pressure casting on account of their mechanical stability from the welds. Thus, the infiltration bodies are placed in the mold and cast under a pressure from 10 bar to 15 bar, and subsequently solidified under a pressure of up to 1,000 bar.

The production of local composite materials in the cylinder crankcase by means of the infiltration body makes possible both an increase in strength and an improvement in wear resistance. Moreover, the tribological properties can be influenced in a controlled manner and sliding properties can be established.

A further advantage of the use of the infiltration body made of inductively welded metal particles is that the infiltration bodies have a weight advantage over monolithic cast parts based on iron. Moreover, gap-free casting is made possible by the complete infiltration of the casting material in the infiltration body.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a photomicrograph at a resolution of 40 μm in a region between casting material and infiltration body,

FIG. 2 shows an enlarged detail of a region II from FIG. 1, and

FIG. 3 shows an enlarged view of a region III as the edge region of the infiltration body from FIG. 1.

### DETAILED DESCRIPTION

An exemplary embodiment invention is explained in detail below on the basis of an infiltration experiment using open-cell metal foam.

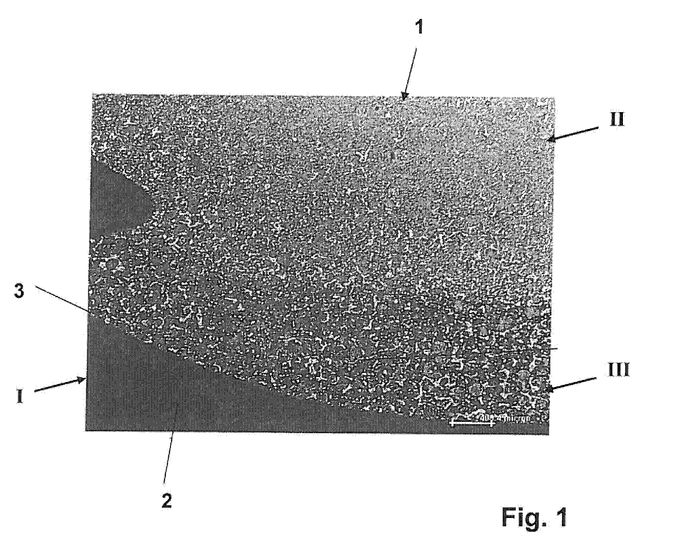

Shown in FIG. 1 is a photomicrograph of an infiltration body 1, which is cast in a casting material 2. The infiltration body 1 here has two clearly distinguishable areas II and III. The edge region III of the infiltration body 1 here is directly enclosed by the casting material 2, which is a light metal alloy such as aluminum or magnesium, for example. The casting material 2 here has completely penetrated the infiltration body, and has formed the two clearly distinguishable regions II and III partly by forming intermetallic phases.

The infiltration body 1 in this example embodiment is produced from a molded article made from the brand name “Astaloy CrM” having a density of 3.5 g/cm³. The aluminum-silicon alloy AlSi12 CuNiMg was selected as the casting material. The eutectic aluminum-silicon alloy has completely penetrated the infiltration body 1. FIG. 1 illustrates very clearly how precisely the composite material formation can be established according to the invention. The infiltration body 1 was preheated under atmospheric conditions to approximately 500°, resulting in oxide formation on the surface of the metal particles. Because of this oxidation of the edge region III of the infiltration body 1, the formation of intermetallic phases was inhibited here. The oxide barriers 5, 6 are clearly visible in FIG. 3, which shows an enlarged view of the oxidized edge region Ill. Although the metal particles 7 have all been completely surrounded by the aluminum alloy 8, the formation of intermetallic compounds was prevented by the oxide coating of the infiltration body 1. FIG. 3 thus clearly shows how preheating can be regulated in a controlled manner, wherein the length of the preheating governs the oxide coating of the infiltration body 1 and thus of the inductively bonded metal particles 7. In the case of longer preheat times under atmospheric conditions, the edge region III can be shifted into the core of the infiltration body 1. Naturally, the method of coating the infiltration body can likewise be applied to the other coating methods claimed.

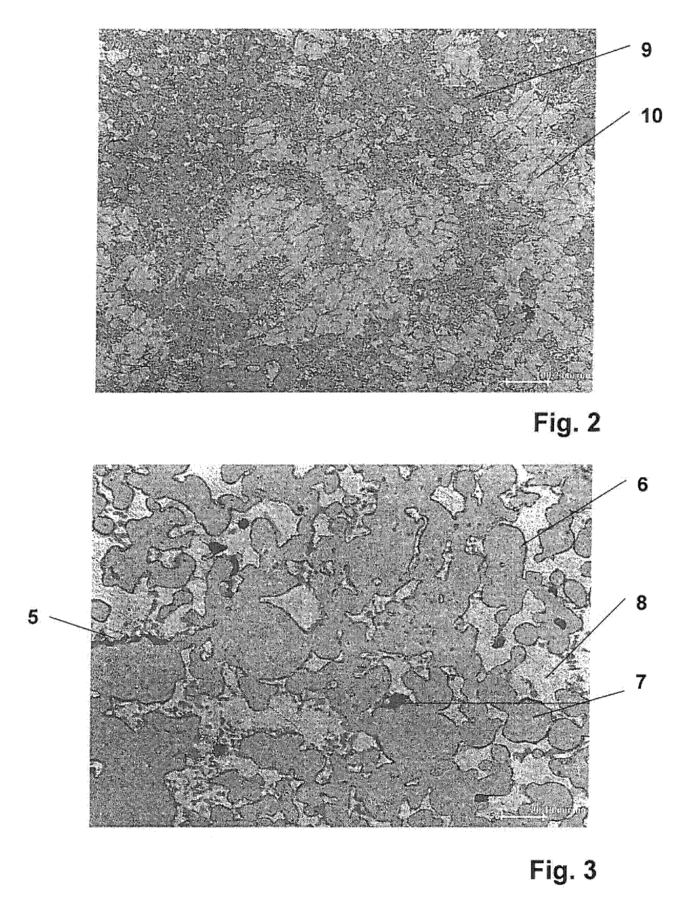

Accordingly, if an aluminide formation is desired, which is to say a formation of intermetallic compounds between the metal particles 7, 9 and the casting material 8, 10, then no coating is deposited on the infiltration body 1, and a material structure forms with intermetallic compounds and homogeneous transitions between the metal particles 9 and the casting material 10, as is shown in FIG. 2. FIG. 2 here shows an enlarged view of the region 2 near the center of the infiltrated infiltration body 1, which took the form of an open-cell metal foam 1 prior to casting.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A quasi-monolithic cylinder crankcase cast in a metal permanent mold for an internal combustion engine, the crankcase comprising an infiltration body penetrating the cylinder crankcase, the infiltration body having an inductively welded, fused, open-cell molded article, a degree of porosity of the infiltration body being between 20% and 70%, and the casting material penetrating the infiltration body completely and forming intermetallic phases.

2. The cylinder crankcase according to claim 1, wherein the molded article is made of metal particles based on iron and/or nonferrous metals.

3. The cylinder crankcase according to claim 2, wherein the metal particles have an average size from 0.1 mm to 1.5 mm.

4. The cylinder crankcase according to claim 1, wherein the surface of the infiltration body is coated, and wherein the surface is oxidized or nitrided or provided with an organic coating.

5. The cylinder crankcase according to claim 1, wherein the infiltration body is an infiltration body formed in a shape of a hollow cylinder forming the cylinder running surface or forming at least a part of a bearing shell.

6. The cylinder crankcase according to claim 1, wherein the cylinder crankcase is made of a light metal alloy and the infiltration body is completely infiltrated by the light metal alloy.

7. The cylinder crankcase according to claim 6, wherein the infiltration body is made of iron and/or nickel and/or chromium and/or manganese and/or their alloys, and at least a partial transformation of the materials takes place so that a composite material and/or an intermetallic phase is formed.

8. A method for producing an infiltration body for a cylinder crankcase according to claim 1, the method comprising:
subjecting a molded article made of electrically conductive metal particles to an induced current; and
fusing the metal particles at their points of contact,
wherein the molded article is made of metal particles with an average size from 0.1 mm to 1.5 mm and is made through vibration or by pressure packing.

9. The method for producing an infiltration body according to claim 8, wherein the molded article is made of a mixture of metal particles and fillers, and wherein organic and/or inorganic components are used as fillers.

10. The method for producing an infiltration body according to claim 9, wherein resins and/or plastics and/or cellulose and/or gelatins and/or salts are used as fillers.

11. The method for producing an infiltration body according to claim 9, wherein the fillers are vaporized during the induction welding process so that a porous molded article with a degree of porosity of 20% to 70% is formed.

12. The method for producing an infiltration body according to claim 8, wherein the molded article is subjected to an inductive medium frequency field with a wavelength from 1 kHz to 400 kHz.

13. An infiltration body according to claim 8, which is made from a powder having electrically conductive metal particles and in which the metal particles are fused by an induced current, wherein the infiltration body is made from a powder having metal particles and/or organic and/or inorganic fillers, wherein the degree of porosity of the infiltration body is established via the filler.

14. The infiltration body according to claim 13, wherein the infiltration body is an open-cell metal foam.

15. The infiltration body according to claim 13, wherein the infiltration body has a degree of porosity between 20% and 70%.

16. The infiltration body according to claim 13 wherein the surface of the infiltration body is coated, in particular oxidized or nitrided or provided with an organic coating.

17. A method for producing a cylinder crankcase according to claim 1, having a penetrated infiltration body according to claim 14, in which the infiltration body is placed in a casting mold and the light metal alloy is subsequently introduced into the casting mold, wherein the light metal alloy is solidified under pressure.

18. The method for producing a cylinder crankcase according to claim 17, wherein the infiltration body is heated to a temperature from 300° C. to 800° C. prior to insertion.

19. The method for producing a cylinder crankcase according to claim 17, wherein the light metal alloy is infiltrated under a pressure from 10 to 20 bar, and is solidified under a pressure up to 1,000 bar.
